(19) United States
(12) Patent Application Publication
(10) Pub. No.: US 2014/0117790 A1
(43) Pub. Date: May 1, 2014

(54) ROTATING ELECTRICAL MACHINE

(71) Applicant: NIPPON PISTON RING CO., LTD., Saitama-shi (JP)

(72) Inventors: Masafumi SAKAMOTO, Shimotsuga-gun (JP); Shigeyoshi SATO, Shimotsuga-gun (JP); Shunsuke TAKEGUCHI, Shimotsuga-gun (JP)

(73) Assignee: NIPPON PISTON RING CO., LTD., Saitama-shi (JP)

(21) Appl. No.: 14/066,910

(22) Filed: Oct. 30, 2013

(30) Foreign Application Priority Data
Oct. 31, 2012 (JP) 2012-241084

(51) Int. Cl. H02K 1/18; H02K 1/02

(52) U.S. Cl. CPC H02K 1/185; H02K 1/02
USPC 310/44

(57) ABSTRACT

An electrical machine having high torque and reliability and low cost, has a stator and rotor facing each other via an air gap, and a bracket at each of both shaft-direction end surfaces of the stator and rotor. The stator core is formed of a dust core, and a stator side guide portion projecting in the shaft direction concentrically with an inner peripheral portion of the stator, is provided on each of both side surface portions of the stator core, a bracket side guide portion, which is fitted to the stator side guide portion, is provided at each of the brackets, and the air gap is secured by making the stator side guide portion fitted to the bracket side guide portion.

### BACKGROUND OF THE INVENTION

1. Field of the Invention

The present invention relates to a rotating electrical machine, such as a small electric motor and generator.

2. Description of the Related Art

In the market, there has been a strong demand for miniaturization and thinning of rotating electrical machines which are small-sized to medium-sized electric motors or generators having output power of about 1 kW or less. Further, in recent years, demand for high-efficiency and energy-saving rotating electrical machines, in the case of use as electric motors, as a global warming countermeasure, has been growing. Also, in the case of use as generators, as a result of reviewing the use of renewable energy as an alternative of nuclear power, the demand for a small wind power generator for home use has also been growing. Further, lower cost has also been strongly demanded for these rotating electrical machines. The rotating electrical machine is classified into a radial gap type rotating electrical machine and an axial gap type rotating electrical machine. The radial gap type rotating electrical machine has been widely used as a general purpose machine because of the advantages that the size of air gap can be reduced, and that the area facing the air gap can be easily increased in the shaft direction of the rotating electrical machine. However, because of the above-described reasons, further improvements in torque and efficiency have been required for the radial gap type rotating electrical machine.

Radial gap type rotating electrical machines are disclosed, for example, in “Method for Using Stepping Motor” (written by Masafumi Sakamoto, published by Ohmsha, Ltd., Japan).

1) In a conventional general purpose radial gap type rotating electrical machine, that is, in case of a brushless DC motor (hereinafter referred to as BLDC motor) and a synchronous generator in each of which a permanent magnet is used in a rotor, or in case of a switched reluctance motor (hereinafter referred to as SR motor) in which no permanent magnet is provided in the rotor but magnetic body teeth are provided in the rotor, the stator core is configured by laminating silicon steel plates. Further, when low cost and efficiency are particularly required, the winding is formed by a concentrated winding method. This is because, in a distributed winding method, the coil end portion, which does not contribute to torque generation, is increased, so that copper loss is increased to reduce the efficiency, and because the winding and wiring become complicated. On the other hand, in the concentrated winding method, the winding is simple and can be directly wound around the slot, so that the winding is made less expensive. In the case where a rotating electrical machine is practically configured to use the concentrated winding method, the number of stators is limited to four to twelve mainly in terms of cost of the rotating electrical machine. An object of the present invention is to provide a rotating electrical machine which has the advantages of the radial gap type rotating electrical machine and can be easily assembled, and which has significantly improved efficiency.

2) In order to improve the efficiency of a rotating electrical machine, it is effective to reduce the air gap between the stator and the rotor. Devices for this include an inner spigot structure of a rotating electrical machine, which structure is illustrated in the right figure of FIG. 2.32 of “Method for Using Stepping Motor” (written by Masafumi Sakamoto, published by Ohmsha, Ltd., Japan). The figure of “Method for Using Stepping Motor” (written by Masafumi Sakamoto, published by Ohmsha, Ltd., Japan) as a prior art corresponds to FIG. 5 in this specification. The prior art is a hybrid type stepping motor (hereinafter referred to as HBSTM) and has been widely adopted. In the case of HBSTMs, the air gap is generally as small as about 0.05 mm. In order to mass-produce HBSTMs with an air gap of this value, a structure is adopted, which is referred to as an “inner spigot” structure, and in which a part of each of front and rear brackets is not fitted to a part of an outer peripheral portion of the stator but is directly fitted to a part of an inner peripheral portion of the stator and guides the both front and rear brackets so as to secure the air gap as “Method for Using Stepping Motor” (written by Masafumi Sakamoto, published by Ohmsha, Ltd., Japan). In the figure of “Method for Using Stepping Motor” (written by Masafumi Sakamoto, published by Ohmsha, Ltd., Japan), reference numerals 5 and 6 respectively denote the front and rear brackets, and a laminated portion of silicon steel plates is arranged between the front and rear brackets 5 and 6. The laminated portion is provided with a winding 4, so as to configure a stator. Further, a structure, in which a rotor is arranged inside the stator, is disclosed. In the rotating electrical machine which is described in “Method for Using Stepping Motor” (written by Masafumi Sakamoto, published by Ohmsha, Ltd., Japan) and in which the stator is configured by laminating silicon steel plates, even when the air gap is set to about 0.05 mm, the air gap can be sufficiently secured in mass production. However, as described in “Method for Using Stepping Motor” (written by Masafumi Sakamoto, published by Ohmsha, Ltd., Japan), the prior art has a problem that the shaft direction length of the rotor portion becomes shorter than the lamination length of the stator portion, so that the facing area of the air gap portion is reduced.

### SUMMARY OF THE INVENTION

The present invention is realized by the following devices.

“Device 1”

A radial gap type rotating electrical machine including a stator and a rotor facing each other via an air gap, and a bracket provided at each of both shaft-direction end surfaces of the stator and the rotor, the rotating electrical machine being realized by a device wherein:

the stator is provided with a stator core including an annular yoke portion and a plurality of winding poles radially extending from the annular yoke portion;

a winding is concentrically wound around each of the winding poles, and the distal end portion of the winding pole faces the rotor via the air gap;

the stator core is formed of a dust core, and a stator side guide portion, which is made to project in the shaft direction concentrically with an inner peripheral portion of the stator, is provided on each of both side surface portions of the stator core;

a bracket side guide portion, which is fitted to the stator side guide portion, is provided at each of the brackets; and

the air gap is secured by making the stator side guide portion fitted to the bracket side guide portion.

“Device 2”

The rotating electrical machine as described in “device 1”, the rotating electrical machine being realized by a device wherein:

a plurality of teeth are provided at the distal end portion of each of the winding poles;

the rotor includes, at an outer peripheral portion thereof, teeth facing the teeth provided at the distal end portion of each of the winding poles and is configured so that a permanent magnet magnetized in the shaft direction is sandwiched between divided portions of the rotor;

the rotor is further fixed to a rotor shaft in a state where the teeth of the divided portion of the rotor arranged on one side of the permanent magnet are shifted by 180 degrees in electric angle with respect to the teeth of the divided portion arranged on the other side of the permanent magnet;

the stator and the rotor are respectively provided with overhang portions which project in the shaft direction to face each other via the air gap; and

at least one of bearings respectively provided on both sides of the rotor is located so as to be substantially received in a recessed portion of the overhang portion of the rotor.

“Device 3”

The rotating electrical machine as described in one of “device 1” and “device 2”, the rotating electrical machine being realized by a device

wherein a winding groove of each of the winding poles of the stator is formed so that the shaft direction thickness of the core at the winding groove is reduced in the direction from the center to the outside of the stator.

“Device 4”

The rotating electrical machine as described in one of “device 1” to “device 3”, the rotating electrical machine being realized by a device

wherein the stator core is divided into portions respectively corresponding to the winding poles, and the divided portions, each of which is provided with a winding, are assembled together.

“Device 5”

The rotating electrical machine as described in one of “device 1” to “device 4”, the rotating electrical machine being realized by a device

wherein the dust core forming the stator core is subjected to one of or both of resin coating treatment and resin impregnation treatment.

1) The outer peripheral portion of the stator is not used as a guide for securing the air gap, but the stator side guide portion and the bracket side guide portion are configured to be fitted to each other for securing the air gap, and hence the external shape of the rotating electrical machine can be made small.

2) In the case of a HBSTM having a small air gap, the inner spigot structure is not used, and hence the facing area of the stator and the rotor can be increased, so that a structure advantageous to achieve high torque is obtained.

3) Further, the stator and the rotor are made to project in the shaft direction to form the overhang structure, and thereby the facing area of the stator and the rotor can be further increased.

4) The shaft direction thickness of the core at the groove recessed portion of the winding portion is reduced in the direction from the center to the outside of the stator, so that the space factor of the winding can be further increased, and hence the efficiency of the rotating electrical machine can be improved.

5) The stator is configured by the divided cores, so that the winding space factor can be significantly improved, and hence higher torque can be obtained.

6) The dust core is used, and thereby it is possible to obtain a highly efficient rotating electrical machine which has almost no eddy current loss and in which the iron loss is small especially at the time of high speed rotation.

### BRIEF DESCRIPTION OF THE DRAWINGS

FIG. 1 is a sectional view including a shaft of a rotating electrical machine according to an example of the present invention;

FIG. 2 is a sectional view taken along line II-II of FIG. 1;

FIG. 3 is a sectional view including a shaft of a rotating electrical machine according to another example of the present invention;

FIG. 4 is a sectional view including a shaft of a rotating electrical machine according to still another example of the present invention;

FIG. 5 is a sectional view including a shaft of a rotating electrical machine of a prior art; and

FIG. 6 is a sectional view taken along line VI-VI of FIG. 5.

### DETAILED DESCRIPTION OF THE PREFERRED EMBODIMENTS

In the following, the present invention will be described with reference to the accompanying drawings.

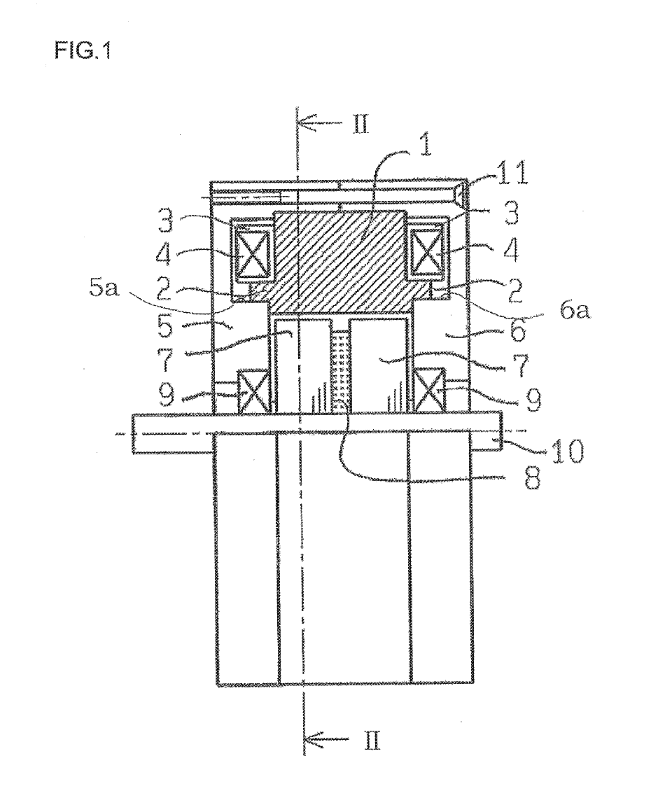

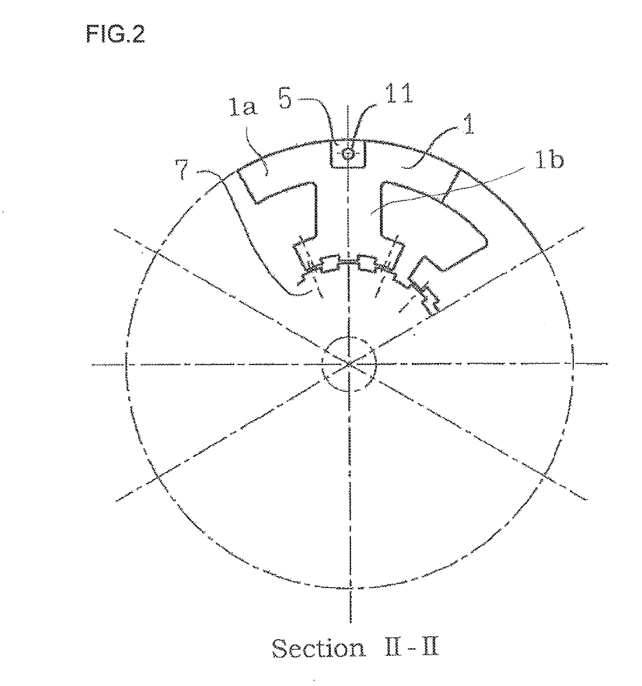

FIG. 1 shows an example of a configuration according to the present invention, and is a sectional view including a rotation axis center of a HBSTM according to the present invention. FIG. 2 is a sectional view which is seen from the direction of the rotation axis center of FIG. 1 and which is taken along line II-II of FIG. 1.

In FIG. 1 and FIG. 2, reference numeral 1 denotes a stator formed of dust cores. Further, reference numeral 2 denotes a flange-like stator side guide portion which is made to project in the shaft direction from the stator 1 and which is formed to have a circular arc shape concentric with the inner diameter of the stator 1. The dust core is manufactured in such a manner that, by mixing soft magnetic iron powder with a small amount of resin as a lubricant or binder, the iron power particles are coated with the resin so that electrical insulation between the iron powder particles is increased to reduce eddy current, and that the mixture is compressed and molded and then sintered. In a rotating electrical machine using the dust core, the core can be formed into a complicated three-dimensional shape, while, in a rotating electrical machine using a core formed by laminating silicon steel plates, the core has a simple two-dimensional shape. Further, the core formed of the dust core has a characteristic that eddy current loss, which is a part of iron loss, is small. Further, the dust core described above has a disadvantage that the magnetic flux density is lower than the core formed by laminating silicon steel plates. However, the dust core can be suitably used for improving the efficiency of the rotating electrical machine in such a manner that the dust core is formed into a so-called overhang shape in which the core can be provided even in areas around the coil end portion of the winding, that is, the armature portion so as to increase the facing area of the stator and the rotor. When the dust core is used in this way, it is possible to easily form, in the rotating electrical machine, the overhang shape, a three-dimensional gap structure, and the like, which are difficult to be formed by using the method of laminating silicon steel plates. The stator 1 and the stator side guide portion 2 can be simultaneously formed by molding compacted powder by using a same mold. Therefore, when the stator side guide portion 2 to be formed to have a circular arc shape concentric with the inner diameter of the stator 1 is provided at a position close to the inner diameter of the stator 1, the circular arc-shaped stator side guide portion 2 can be formed to have extremely high concentricity with respect to the inner diameter of the stator 1. Generally, the size of the air gap of a HBSTM needs to be reduced to as small as 0.05 mm, which precision can be sufficiently achieved by the centering guide of the present invention.

Reference numeral 3 denotes an insulator, and reference numeral 4 denotes a winding. Each of reference numerals 5 and 6 denotes a bracket which is made of an aluminum material, or the like, to rotatably hold a rotor 7 via a bearing 9, and which serves to secure the air gap between the rotor 7 and the stator 1. The brackets are respectively provided with cylindrical bracket side guide portions 5a and 6a each of which is formed concentrically with an inner diameter portion into which the bearing 9 is fitted. The outer diameter portion of each of the bracket side guide portions 5a and 6a is fitted to the inner diameter portion of the stator side guide portion 2 of the stator 1 so that the air gap is secured. Reference numeral 8 denotes a permanent magnet, such as a neodymium magnet, magnetized in the shaft direction. Reference numeral 10 denotes a rotary shaft. Reference numeral 11 denotes a bolt. The front and rear brackets 5 and 6 are tightened and fixed to each other by the bolts 11 so as to sandwich the stator 1 therebetween. In order to prevent that the stator 1 is deformed by excessive force generated by the screw fastening force of the bolts 11 at this time, it is configured such that arms respectively extending in the shaft direction from the front and rear brackets 5 and 6 are brought into contact with each other by being inserted into U-shaped grooves formed in the outer peripheral portion of the stator 1, and thereby receive the force generated by the screw fastening force of the bolts 11. For this reason, the front and rear brackets 5 and 6 are not used for concentrically guiding the outer periphery of the stator 1, and hence the outer diameter of the motor is not increased.

The rotor 7 is formed by laminating silicon steel plates, but may be formed by a dust core. In the case of a HBSTM, the magnetic flux of the permanent magnet also flows in the shaft direction through a portion of each of the rotor and the stator. Therefore, even when the permeability of compacted powder is lower than the permeability of silicon steel plate, it can be expected that the interlinkage magnetic flux of the HBSTM using the dust core is increased in spite of the lower permeability of the dust core. FIG. 2 shows an example of a case where, in the stator configuration shown in FIG. 1, the stator is configured by six divided cores which are made of compacted powder and arranged in the circumferential direction so as to respectively form winding poles. Each of the divided cores 1 includes an annular yoke portion 1a configuring the outer periphery of the stator 1, and a winding pole 1b radially extending from the annular yoke portion 1a. In the case where divided cores are used, the winding can be easily configured, and the amount of copper used for the winding can be increased, so that the winding space factor can be increased to as high as 60% or more. In the case of a HBSTM having a stator configured by a single body core, the winding space factor is as low as about 30%. The torque generated by a motor is proportional to the square root of copper amount, and hence the torque can be increased to as much as the square root of two times.

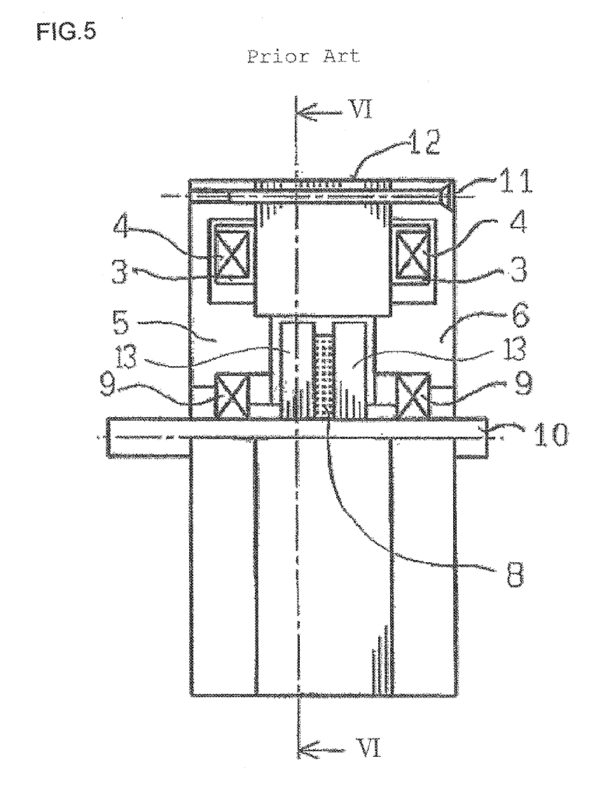

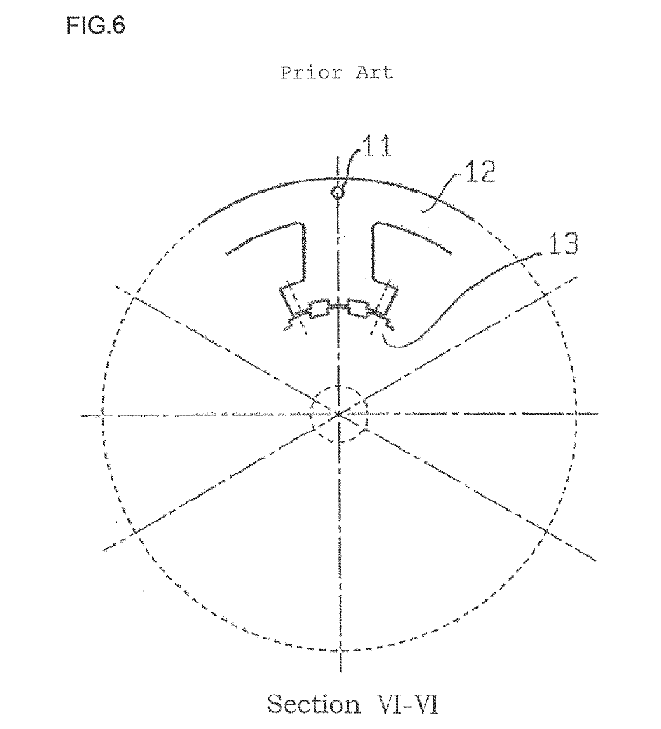

An example of the prior art will be described with reference to FIG. 5. In FIG. 5, components having the same functions as those in FIG. 1 are denoted by the same reference numerals. FIG. 6 is a sectional view taken along line VI-VI of FIG. 5. Reference numeral 12 denotes a stator formed by laminating silicon steel plates. In the case of HBSTMs, the air gap is as small as about 0.05 mm, and hence the inner spigot structure described above is adopted. Unlike the outer spigot structure in which a guide of the front and rear brackets is provided on an outer diameter portion of the stator, the inner spigot structure has an advantage that the outer diameter of the motor is not increased. However, in the inner spigot structure, the guide flanges of the front and rear brackets 5 and 6 are respectively extended by about 2 mm to the inner side from both sides of the inner diameter portion of the stator 12, and further, the shaft direction gap between each of the brackets 5 and 6 and a rotor 13 is set to have a distance of about 1 m. Therefore, the inner spigot structure has a disadvantage that the effective length of the rotor 13 is reduced. This also results in a disadvantage that the facing area of the stator and the rotor is reduced. The dimensions of the permanent magnet 8 and the winding illustrated in FIG. 5 are the same as those in FIG. 1, and hence the motor length in FIG. 5 is the same as that in FIG. 1. From FIG. 5 and FIG. 1, it can be seen that the rotor 7 according to the present invention can be formed to have a shaft direction length 1.8 times longer than the shaft direction length of the rotor 13 of the prior art. That is, even in view of only the facing area of the stator and the rotor, it is expected that the torque can be increased by about 1.8 times as compared with the prior art.

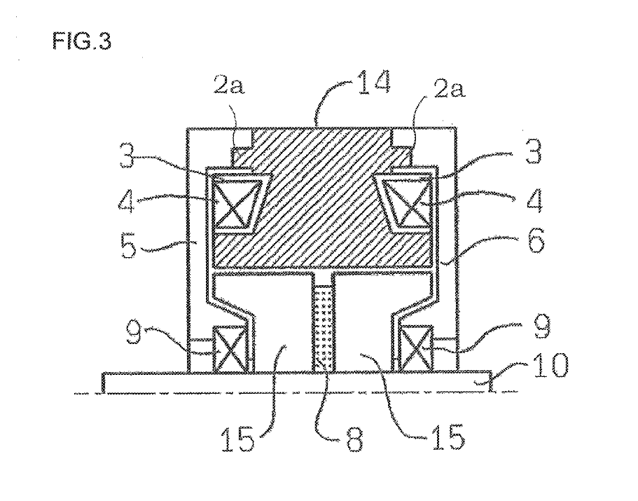

FIG. 3 is an illustration of another example of the present invention. In FIG. 3, components having the same functions as those in FIG. 1 are denoted by the same reference numerals. Reference numeral 14 denotes a dust core. Similarly to the stator 1 of FIG. 1, each of stator side guide portions 2a and 2a with respect to the front and rear brackets 5 and 6 is formed into a flange shape concentrically projecting to the shaft direction side of the stator 14. However, the stator 14 is different from the stator of FIG. 1 in the following points.

(1) The stator side guide portions 2a and 2a are provided on the outer peripheral side of the winding portion 4 of the stator 14.

(2) The facing area of the stator 14 and a rotor 15 is increased in such a manner that the portion of the stator 14, which portion is located on the inner side of the winding, is made to project in the shaft direction so as to form an overhang structure, and that the portion of the rotor 15, which portion faces the projecting portion of the stator 14, is also made to project in the shaft direction so as to form an overhang structure.

(3) The stator winding groove portion of the stator 14 is formed into a tapered groove so that the shaft direction thickness of the core forming the bottom portion of the groove recessed portion of the winding portion 4 is reduced in the direction from the center to the outside of the stator 14.

(4) The bearings 9 are provided on both sides of the rotor 15 so that at least one of the bearings 9 is located so as to be substantially received in the recessed portion of one of the overhang portions of the rotor 15 which are provided on both sides of the rotor 15 in the shaft direction.

The increase in the facing area (2) can be attained by using the effect of the configuration (1) described above.

The configuration, in which the stator winding groove portion is formed into a tapered groove so that the shaft direction thickness of the core forming the groove recessed portion of the winding portion is reduced in the direction from the center to the outside of the stator, is a contrivance that, when in a radial gap type motor, the winding is formed so as to increase the coil end height toward the outer side in the radial direction, the coil end height is made uniform in the radial direction while the copper amount is increased. This configuration cannot be formed by the lamination method of laminating silicon steel plates and can be easily formed by adopting a dust core.

Further, the configuration (4) is additionally described. In FIG. 3, the bearings 9, such as ball bearings, provided on both sides of the rotor 15 are respectively received in the front and rear recessed portions of the overhang portions of the rotor 15 which are provided in the shaft direction. This configuration contributes to reduce the shaft direction length of the motor and hence contributes to the miniaturization and thinning of the motor. In FIG. 3, the left side bearing 9 may be arranged to be shifted to the left side from the recessed portion of the overhang portion of the rotor 15 so that a part of the bracket 5 is made to project by the shifted length so as to serve as the attachment guide of the motor. In this case, the effective motor length is not increased. Therefore, in the above, it is described that at least one of the bearings 9 is substantially received in the recessed portion of the overhang portion. When the shaft direction length of the rotor of the present invention shown in FIG. 3 and the shaft direction length of the rotor of the prior art shown in FIG. 5 are compared with each other on the basis of the same motor length, the shaft direction length of the rotor according to the present invention is increased as much as three times. In view of the effect of the tapered groove for the winding in addition to this effect, it can be seen that the present invention greatly contributes to increase the torque of the motor.

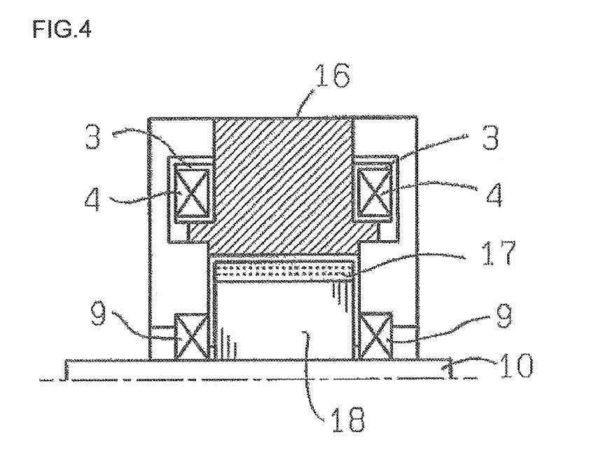

FIG. 4 is an illustration of still another example of the present invention. In FIG. 4, components having the same functions as those in FIG. 1 are denoted by the same reference numerals.

Reference numeral 16 denotes a stator formed of compacted powder. The configuration shown in FIG. 4 is basically the same as the configuration shown in FIG. 1 except the rotor. However, the illustration of the bolt denoted by reference numeral 11 is omitted. Reference numeral 17 denotes a rotator permanent magnet having a cylindrical shape. Reference numeral 18 denotes a back yoke of the rotator permanent magnet 17 and also serves as an inner component between the shaft 10 and the rotator permanent magnet 17. A motor and a generator of this kind are shown in “Method for Using Stepping Motor” (written by Masafumi Sakamoto, published by Ohmsha, Ltd., Japan) described above. In many cases, the air gap is reduced to as small as about 0.06 mm, and hence the inner spigot structure is adopted. In the case where the efficiency is to be improved by reducing the air gap, the centering guide structure using the side surface of the dust core stator according to the present invention is very effective for increasing the facing area of the stator and the rotor. Further, although not shown, when the rotor of FIG. 4 is configured only by a magnetic body having teeth of the same shape as the teeth of the rotor 7 of FIG. 1, the motor shown in FIG. 4 is configured as a variable stepping motor which is referred to as a VR type motor and in which no permanent magnet is used, and an SR motor which performs closed-loop driving of the VR type stepping motor. The present invention is also effective for these rotating electrical machines.

Note that it is preferred that the dust core forming the stator core shown in FIG. 1 to FIG. 4 be subjected to one of or both of resin coating treatment and resin impregnation treatment in order to improve the strength and durability thereof. Here, when the treatment is performed, the specific method of the treatment is not limit in particular, and any method can be adopted as long as the method enables the surface of the dust core to be coated with resin and enables resin to be impregnated into the dust core. Specifically, examples of the treatment include electro-deposition coating, electrostatic coating, dipping, and the like. Note that the resin used here is not limited in particular, and various resin can be suitably selected and used. Further, when the dipping is performed, it is possible to use a generally used dipping liquid which contains liquid adhesive or varnish.

Since a HBSTM motor or a BLDC motor uses a permanent magnet and hence requires no electrical input for field magnetic flux, it can be said that the motor is a highly efficient rotating electrical machine. However, in recent years, among permanent magnets, the price of rare-earth magnets, such as a neodymium magnet, having high magnetic energy, has been significantly increased, and hence it is necessary to improve the efficiency of the HBSTM motor or the BLDC motor while reducing the use amount of magnet. It can be said that the present invention is very effective as a solution for this problem.

The rotating electrical machine according to the present invention can be used for an electric motor or generator and is very practical and suitable for obtaining a less expensive, small and light electric motor or generator having high mechanical strength, high torque and high efficiency. Therefore, it is expected that the present invention makes great industrial contributions.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2012-241084 filed on Oct. 30, 2012 including the specification, claims, drawings and summary is incorporated herein by reference in its entirety.

1. A radial gap type rotating electrical machine including a stator and a rotor facing each other via an air gap, and a bracket provided at each of both shaft-direction end surfaces of the stator and the rotor, wherein:
the stator is provided with a stator core including an annular yoke portion and a plurality of winding poles radially extending from the annular yoke portion;
a winding is concentrically wound around each of the winding poles, and a distal end portion of the winding pole faces the rotor via the air gap;
the stator core is formed of a dust core, and a stator side guide portion, which is made to project in the shaft direction concentrically with an inner peripheral portion of the stator, is provided on each of both side surface portions of the stator core;
a bracket side guide portion, which is fitted to the stator side guide portion, is provided at each of the brackets; and
the air gap is secured by making the stator side guide portion fitted to the bracket side guide portion.

2. The rotating electrical machine according to claim 1, wherein:
a plurality of teeth are provided at the distal end portion of each of the winding poles;
the rotor includes, at an outer peripheral portion thereof, teeth facing the teeth provided at the distal end portion of each of the winding poles and is configured so that a permanent magnet magnetized in the shaft direction is sandwiched between divided portions of the rotor;
the rotor is further fixed to a rotor shaft in a state where the teeth of the divided portion of the rotor arranged on one side of the permanent magnet are shifted by 180 degrees in electric angle with respect to the teeth of the divided portion arranged on the other side of the permanent magnet;
the stator and the rotor are respectively provided with overhang portions which project in the shaft direction so as to face each other via the air gap; and
at least one of bearings respectively provided on both sides of the rotor is located so as to be substantially received in a recessed portion of the overhang portion of the rotor.

3. The rotating electrical machine according to claim 1, wherein a winding groove of each of the winding poles of the stator is formed so that the shaft direction thickness of the core at the winding groove is reduced in the direction from the center to the outside of the stator.

4. The rotating electrical machine according to claim 1, wherein the stator core is divided into portions respectively corresponding to the winding poles, and the divided portions, each of which is provided with a winding, are assembled together.

5. The rotating electrical machine according to claim 1, wherein the dust core forming the stator core is subjected to one of or both of resin coating treatment and resin impregnation treatment.
